(19) United States
(12) Patent Application Publication
(10) Pub. No.: US 2016/0231861 A1
(43) Pub. Date: Aug. 11, 2016

(54) CONDUCTIVE SHEET, TOUCH PANEL DEVICE, DISPLAY DEVICE, AND METHOD FOR MANUFACTURING CONDUCTIVE SHEET

(71) Applicant: SHARP KABUSHIKI KAISHA, Osaka (JP)

(72) Inventors: Kosuke NAGATA, Osaka (JP); Masayuki HATA, Osaka (JP); Mikihiro NOMA, Osaka (JP)

(73) Assignee: Sharp Kabushiki Kaisha, Osaka (JP)

(21) Appl. No.: 15/023,305

(22) PCT Filed: Jul. 25, 2014
(86) PCT No.: PCT/JP2014/069738

§ 371 Date: Mar. 18, 2016

(30) Foreign Application Priority Data
Sep. 25, 2013 (JP) 2013-198899

(51) Int. Cl. G06F 3/041; G06F 3/044

(52) U.S. Cl. CPC G06F 3/0418; G06F 3/044; G06F 2203/04112; G06F 2203/04103

(57) ABSTRACT

A touch panel includes: a substrate; an X axis direction electrode part; and a Y axis direction electrode part. The X axis direction electrode part includes a plurality of fine metal wires formed on one main surface (a first main surface) of the substrate. The Y axis direction electrode part includes a plurality of fine metal wires formed on another main surface (a second main surface) of the substrate. In bridge regions in which the X axis direction electrode part and the Y axis direction electrode part overlap in a plan view, the wiring pattern of the plurality of the fine metal wires included in the X axis direction electrode part is identical to the wiring pattern of the plurality of the fine metal wires included in the Y axis direction electrode part. In the bridge regions, the wire width of the fine metal wires included in the X axis direction electrode part is larger than the wire width of the fine metal wires included in the Y axis direction electrode part.

### TECHNICAL FIELD

The present invention relates to a touch panel device and a conductive sheet used in touch panel devices and the like.

### BACKGROUND ART

A touch panel device is a device in which information can be input into the device via a finger or pen contacting the touch panel surface. In recent years, capacitive touch panel devices, which have good detection sensitivity and excellent operability, have been used in various types of devices. In particular, projection-type capacitive touch panel devices, which can accurately detect the coordinates at which a finger or pen contacts the touch panel surface, are widely used.

Projection-type capacitive touch panel devices include a plurality of drive lines and a plurality of sense lines. A plurality of X axis direction sense electrodes are provided on the respective drive lines, and a plurality of Y axis direction sense electrodes are provided on the respective sense lines. In a projection-type capacitive touch panel device, driving pulse signals are output to the drive lines in a sequential manner, and changes in an electric field between the X axis direction sense electrodes and the Y axis direction sense electrodes are detected. In other words, by detecting signals in the sense lines that correspond to changes in the electric field between the X axis direction sense electrodes and the Y axis direction sense electrodes, the coordinates at which the finger or pen contacted the touch panel surface are detected in the projection-type capacitive touch panel device.

In such a projection-type capacitive touch panel device, sensors (X axis direction sense electrodes, Y axis direction sense electrodes) are formed via mesh-shaped metal wiring lines.

The mesh-shaped metal wiring lines are not transparent. As a result, there are instances in which the metal wiring lines become visible when the wiring lines are not evenly distributed on the touch panel surface, thereby leading to a marked decrease in the visibility of images displayed on a display surface disposed below the touch panel.

Therefore, Patent Document 1 (Japanese Patent Application Laid-Open Publication No. 2013-37683) discloses a technology in which the intensity distribution of reflected light is made to approach a uniform distribution by providing a dummy pattern that has a wiring density that is the same as a conductive pattern (sense electrodes) when X axis direction sense electrodes and Y axis direction sense electrodes are formed on both surfaces of a transparent substrate body. As a result, it is possible in the technology disclosed in Patent Document 1 to prevent decreases in the visibility of the displayed images due to the reflection of outside light.

### SUMMARY OF THE INVENTION

### Problems to be Solved by the Invention

However, in the technology disclosed in Patent Document 1, there is a possibility that there will be decreases in the visibility of the displayed images in a bridge region where the metal wiring lines of the X axis direction sense electrodes and the metal wiring lines of the Y axis direction sense electrodes overlap in a plan view.

In the bridge region, it is difficult to dispose the pattern of the metal wiring lines on the surface (layer) on which the X axis direction sense electrodes are formed and the pattern of the metal wiring lines on the surface (layer) on which the Y axis direction sense electrodes are formed such that the patterns perfectly overlap in a plan view, thus leading to the patterns not matching up. As a result, there will be a difference between light transmissivity in the bridge region and light transmissivity in regions other than the bridge region. Thus, in the bridge region, the metal wiring lines of the sense electrodes will be noticeable, and there will be a decrease in the visibility of displayed images. In particular, it is well known that interference occurs when a structure having a mesh pattern (a sense electrode including metal wiring lines in a mesh pattern, for example) is disposed on the display surface of a liquid crystal display device or the like. It is also well-known that the generation of such interference depends on the pitch of the mesh pattern.

When the conductive sheet disclosed in Patent Document 1 is disposed on the display surface of a liquid crystal display device or the like, as mentioned above, there is a possibility that interference will occur and there will be a decrease in the visibility of displayed images.

The present invention was made with the above-mentioned problems in mind, and aims to realize: a conductive sheet that, even when disposed on a display surface of a liquid crystal display device or the like, appropriately prevents interference and ensures good visibility of displayed images; a touch panel device; a display device; and a method of manufacturing the conductive sheet.

### Means for Solving the Problems

In order to solve the above-mentioned problems, a first configuration is a conductive sheet (a touch panel sheet, for example) that includes a first electrode part and a second electrode part.

The first electrode part includes a plurality of fine metal wires formed in a first plane (a first main surface of a substrate [alternatively, a first layer of a multilayer substrate], for example).

The second electrode part includes a plurality of fine metal wires formed in a second plane (a second main surface of a substrate [alternatively, a second layer of a multilayer substrate], for example).

In a plan view, the wiring pattern of the plurality of fine metal wires included in the first electrode part is identical to the wiring pattern of the plurality of fine metal wires included in the second electrode part in the bridge region in which the first electrode part and the second electrode part overlap.

When viewed from the first plane, in the bridge region, the fine metal wires included in the first electrode part are formed so the width thereof is greater than the width of the fine metal wires included in the second electrode part so that the fine metal wires included in the second electrode part are hidden by the fine metal wires included in the first electrode part.

### Effects of the Invention

According to the present invention, it is possible to realize: a conductive sheet that, even when disposed on a display surface of a liquid crystal display device or the like, appropriately prevents interference and ensures good visibility of displayed images; a touch panel device; a display device; and a method of manufacturing the conductive sheet.

### BRIEF DESCRIPTION OF THE DRAWINGS

FIG. 1 is a schematic configuration diagram of a touch panel TP according to Embodiment 1.

FIG. 2 enlarges a region that is a portion of the touch panel TP in a plan view.

FIG. 3 shows only the X axis direction electrode part 2 from FIG. 2, and shows patterns of fine metal wires included in regions R1, R2.

FIG. 4 shows only the Y axis direction electrode part 3 from FIG. 2, and shows patterns of fine metal wires included in the regions R1, R2.

FIG. 5 enlarges a region that is portion of the touch panel TP in a plan view, and shows the patterns of the fine metal wires included in the regions R1 to R3.

FIG. 6 is a cross-sectional view C-C along the line C-C in FIG. 5.

FIG. 7 shows the cross-section C-C in a case in which a grid pattern of fine metal wires of a width Wyb for the connecting sections of the Y axis direction electrode part 3 are shifted by a positional alignment tolerance “diff” in the positive direction of the a-axis with respect to a grid pattern of fine metal wires of a width Wx for the connecting sections of the X axis direction electrode part 2.

FIG. 8 shows the cross-section C-C in a case in which the grid pattern of fine metal wires of a width Wyb for the connecting sections of the Y axis direction electrode part 3 are shifted by a positional alignment tolerance “diff” in the negative direction of the a-axis with respect to the grid pattern of fine metal wires of a width Wx for the connecting sections of the X axis direction electrode part 2.

FIG. 9 is a cross-sectional view D-D along the line D-D in FIG. 5.

FIG. 10 is a cross-sectional view E-E along the line E-E in FIG. 5.

FIG. 11 is a flow chart of one example of a method of manufacturing the touch panel TP.

FIG. 12 is a schematic configuration diagram of a touch panel TP2 according to Embodiment 2.

FIG. 13 enlarges a region that is a portion of the touch panel TP2 in a plan view, and shows only dummy electrodes (d2321 to d2323, d2331 to d2333) and the X axis direction electrode part 2 formed on a first main surface of a substrate 1.

FIG. 14 enlarges a region that is a portion of the touch panel TP2 in a plan view, and shows only dummy electrodes (d3231 to d3233, d3241 to d3243) and the Y axis direction electrode part 3 formed on a second main surface of a substrate 1.

FIG. 15 enlarges a region that is a portion of the touch panel TP2 in a plan view, and is a plan view as seen from directly above the first main surface of the substrate 1.

FIG. 16 is a cross-sectional view F-F along the line F-F in FIG. 15.

FIG. 17 is a flow chart of one example of a manufacturing method of the touch panel TP2.

### DETAILED DESCRIPTION OF EMBODIMENTS

### Embodiment 1

Embodiment 1 is described below with reference to the drawings.

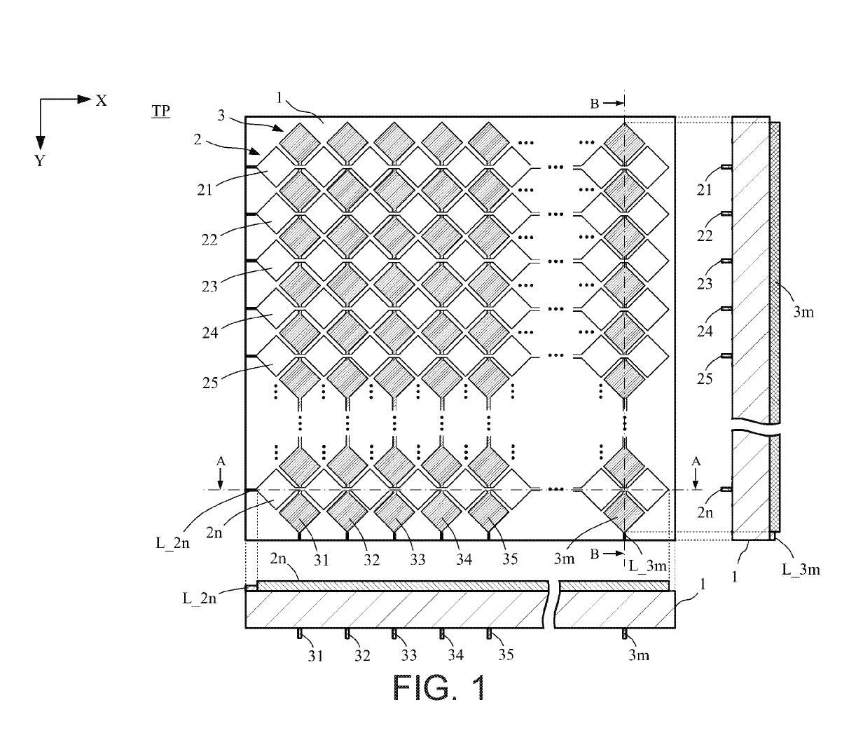

FIG. 1 is a schematic configuration diagram of a touch panel TP that is one example of a conductive sheet according to Embodiment 1. Specifically, FIG. 1 shows a plan view of the touch panel TP, a cross-sectional view A-A (bottom of the figure), and a cross-sectional view B-B (right side of the figure).

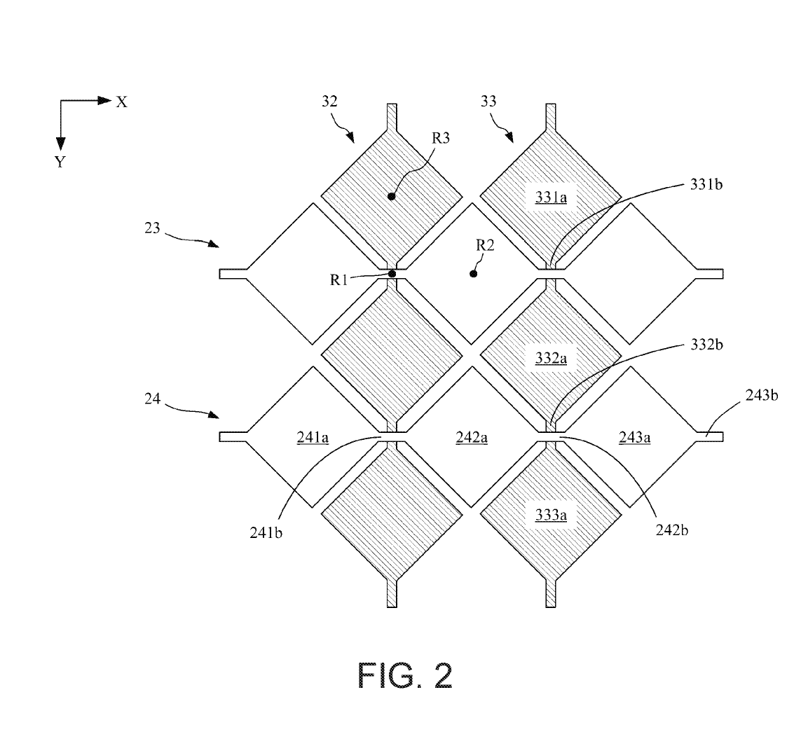

FIG. 2 enlarges a region that is a portion of the touch panel TP of FIG. 1 in a plan view.

As shown in FIGS. 1 and 2, the X axis and Y axis are set in FIGS. 1 and 2.

As shown in FIG. 1, the touch panel TP includes: the substrate 1; the X axis direction electrode part 2 formed on the first main surface of the substrate 1; and the Y axis direction electrode part 3 formed on the second main surface of the substrate 1.

The first substrate 1 has insulating properties and is formed via a material that has high light transmittance (a colorless transparent resin, glass, plastic, PET (polyethylene terephthalate), or the like, for example). It is preferable that the thickness of the substrate 1 be at a thickness such that it is possible to adequately transmit light from the display surface when the substrate 1 is disposed so as to cover the display surface, for example.

As shown in FIG. 1, the substrate 1 also has a rectangular shape in a plan view, for example.

The X axis direction electrode part 2 is formed on the first main surface of the substrate 1. The X axis direction electrode part 2 includes a plurality of electrodes (241a, 242a, 243a shown in FIG. 2, for example) and connecting sections (241b, 242b shown in FIG. 2, for example) that connected adjacent electrodes. Each of the electrodes includes a plurality of fine metal wires disposed so as to form a prescribed pattern. In addition, each of the connecting sections includes a plurality of fine metal wires disposed so as to form a prescribed pattern.

As shown in FIGS. 1 and 2, the plurality of electrodes in the X axis direction electrode part 2 are each arranged in a straight line in the X axis direction in a plan view. As shown in FIGS. 1 and 2, adjacent electrodes are connected to each other via the connecting section.

By forming the electrodes and the connecting sections in this manner, one X axis direction electrode part (23, 24 shown in FIG. 2, for example) is formed in a row. As shown in FIG. 1, by arranging a plurality of X axis direction electrode parts formed in this manner in the Y axis direction, the X axis direction electrode part 2 is formed. In the case of FIG. 1, the X axis direction electrode part 2 is formed via n (n being a natural number) rows of X axis direction electrode parts 2l to 2n, for example.

The X axis direction electrode parts 2l to 2n are respectively connected to drive lines of drive circuits (not shown). By sequentially driving the respective X axis direction electrode parts 2l to 2n via a driving pulse from the drive circuit, it is possible to generate an electric field on the surface of the touch panel TP.

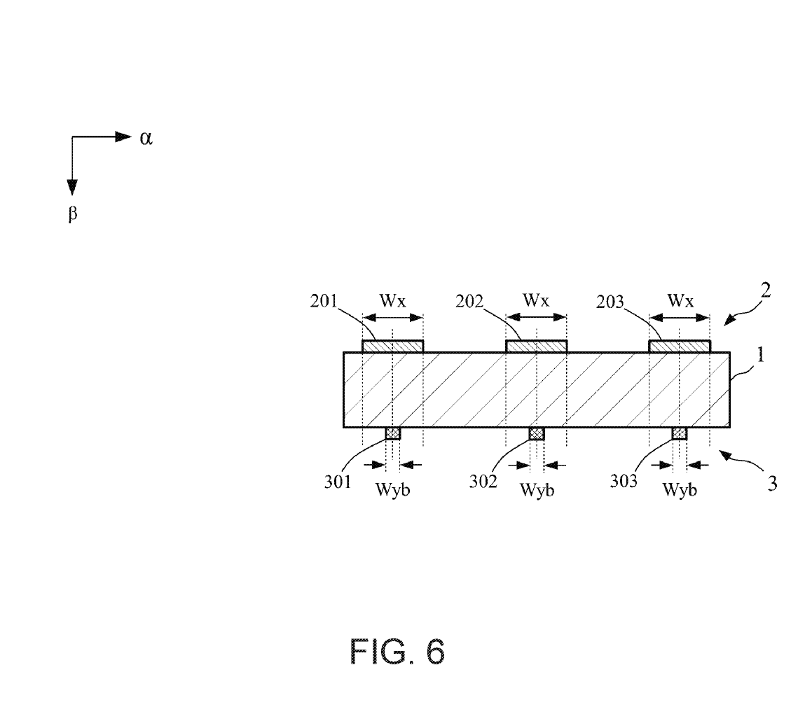

In the present embodiment, the width Wx is the same for each of the electrodes and connecting sections in the X axis direction electrode parts 2l to 2n in the X axis direction electrode part 2. In other words, the width Wx of the fine metal wires included in the electrodes and connecting sections of the X axis direction electrode part 2 is the same in a plan view in both the regions (bridge regions) where the connecting sections of the X axis direction electrode part 2 and the connecting sections of the Y axis direction electrode part 3 overlap and in any other region. In the regions R1, R2 shown in FIG. 2, the width Wx (see FIG. 6, for example) of fine metal wires included in the connecting sections and the electrodes of the X axis direction electrode part 2 is the same, for example.

The Y axis direction electrode part 3 is formed on the second main surface (the main surface opposite to the first main surface) of the substrate 1. The Y axis direction electrode part 3 includes a plurality of electrodes (331a, 332a, 333a shown in FIG. 2, for example) and connecting sections (331b, 332b shown in FIG. 2, for example) that connected adjacent electrodes to each other. Each of the electrodes includes a plurality of fine metal wires disposed so as to form a prescribed pattern. In addition, each of the connecting sections includes a plurality of fine metal wires disposed so as to form a prescribed pattern.

As shown in FIGS. 1 and 2, the plurality of electrodes in the Y axis direction electrode part 3 are arranged in straight lines in the Y axis direction in a plan view. As shown in FIGS. 1 and 2, adjacent electrodes are connected to each other via the connecting section.

By forming the electrodes and the connecting sections in this manner, one Y axis direction electrode part (32, 33 shown in FIG. 2, for example) is formed in a row. As shown in FIG. 1, by arranging a plurality of X axis direction electrode parts formed in this manner in the X axis direction, the Y axis direction electrode part 3 is formed. In the case of FIG. 1, the Y axis direction electrode part 3 is formed via m (m being a natural number) rows of Y axis direction electrode parts 3l to 3m, for example.

The Y axis direction electrode parts 3l to 3m are respectively connected to sense lines of a reception circuit (not shown). By reading current values (or voltage values) and the like generated by the respective Y axis electrode parts 3l to 3m, the reception circuit is able to detect changes in the electric field on the surface of the touch panel TP.

The width Wyb, which is a width of the fine metal wires included in the connecting sections of the Y axis electrode part 3 in the regions (bridge regions) where a connecting section of the X axis direction electrode part 2 and a connecting section of the Y axis direction electrode part 3 overlap in a plan view, satisfies the following formula: Wx≧Wyb+2×diff, where Wx is the width of the fine metal wires included in the X axis direction electrode part 2, and diff is the positional alignment tolerance.

In addition, in the regions (bridge regions) where a connecting section of the X axis direction electrode part 2 and a connecting section of the Y axis direction electrode part 3 overlap in a plan view, the pattern formed by the fine metal wires included in the connecting section of the X axis direction electrode part 2 is identical to the pattern formed by the fine metal wires included in the connecting section of the Y axis direction electrode part 3. In other words, the shape of the pattern formed by the fine metal wires included in the connecting section of the X axis direction electrode part 2 when the width is set to “0” is identical (congruent) to the shape of the pattern formed by the fine metal wires included in the connecting section of the Y axis direction electrode part 3 when the width is set to “0”.

When the fine metal wires of the X axis direction electrode part 2 are formed on the first main surface of the substrate 1 and the fine metal wires of the Y axis direction electrode part 3 are formed on the second main surface of the substrate 1, the positional alignment tolerance “diff” is set as the positional shift error that can be generated in the bridge regions between the pattern formed by the fine metal wires included in the connecting section of the X axis direction electrode part 2 and the pattern formed by the fine metal wires included in the connecting section of the Y axis direction electrode part 3.

At such time, by having the width Wx of the fine metal wires included in the connecting section of the X axis direction electrode part 2 and the width Wyb of the fine metal wires included in the connecting section of the Y axis direction electrode part 3 satisfy in the bridge regions the relationship (inequality) shown above, it is possible to make the fine metal wires included in the connecting section of the Y axis direction electrode part 3 not visible in the bridge regions as a result of being hidden by the fine metal wires included in the X axis direction electrode part 2 when the touch panel TP is viewed from directly above the first main surface of the substrate 1.

This will be explained using FIGS. 2 to 6.

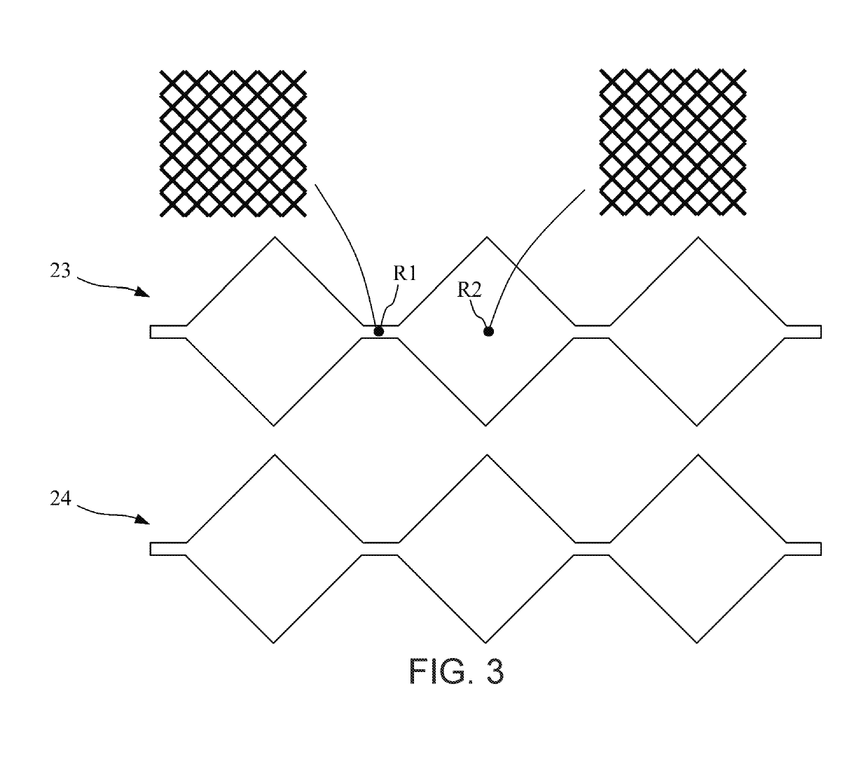

FIG. 3 shows only the X axis direction electrode part 2 from FIG. 2, and shows patterns of fine metal wires included in regions R1, R2. In FIG. 3, the patterns of the fine metal wires are shown by enlarging portions of the regions R1, R2 (the same applies hereinafter).

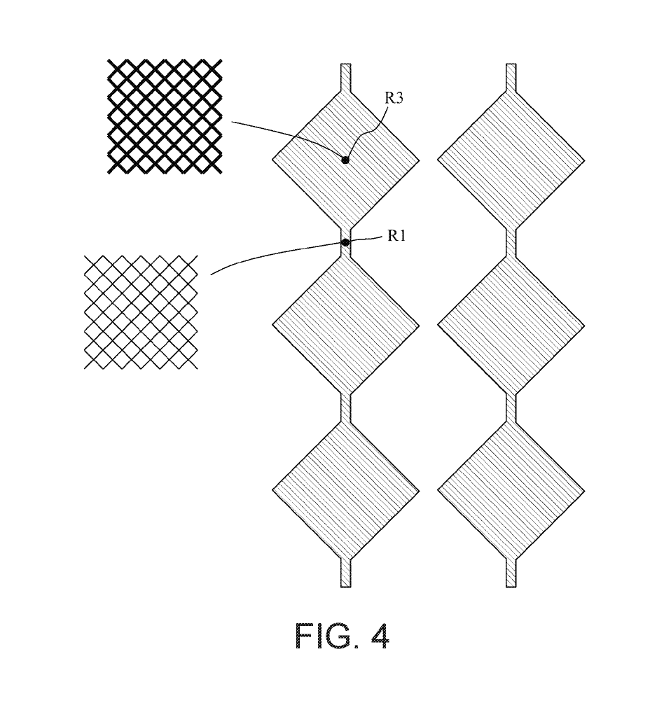

FIG. 4 shows only the Y axis direction electrode part 3 from FIG. 2, and shows patterns of fine metal wires included in the regions R1, R2.

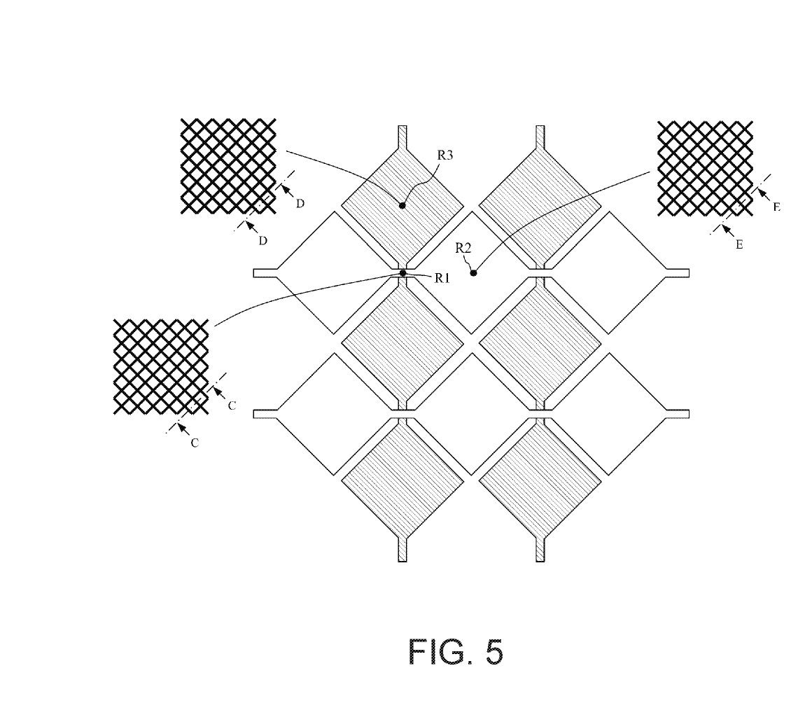

FIG. 5 is similar to FIG. 2, and shows patterns of fine metal wires included in the regions R1 to R3. In FIG. 5, the patterns of the fine metal wires are shown by enlarging portions of the regions R1 to R3 (the same applies hereinafter).

Hereafter, a case as shown in FIGS. 3 to 5, in which the pattern of the fine metal wires is a grid pattern, will be explained.

In the electrodes and the connecting sections of the X axis direction electrode part 2, a grid pattern of fine metal wires with a width Wx is formed. In other words, as shown in FIG. 3, a grid pattern of fine metal wires with a width Wx is formed in both the region R1, which is included in the bridge region, and the region R2, which is a region outside the bridge region.

In the connecting section of the Y axis direction electrode part 3 included in the bridge region, a grid pattern of fine metal wires with a width Wyb is formed. In the electrodes and the connecting sections of the Y axis direction electrode part 3 outside the bridge region, a grid pattern of fine metal wires with a width Wy (Wy>Wyb) is formed. In other words, as shown in FIG. 4, in the region R1 included in the bridge region, a grid pattern of fine metal wires with a width Wyb is formed. Meanwhile, in a region (the region R3, for example) outside the bridge region, a grid pattern of fine metal wires with a width Wy is formed.

Therefore, as shown in FIG. 5, when the touch panel TP is viewed from directly above the first main surface of the substrate 1, a grid pattern of fine metal wires of a width Wx in the electrodes of the X axis direction electrode part 2 is visible in the region R2, and a grid pattern of fine metal wires of a width Wy in the electrodes of the Y axis direction electrode part 3 is visible in the region R3. In addition, a grid pattern of fine metal wires of a width Wx in the connecting sections of the X axis direction electrode part 2 is visible in the region R1. In other words, in the region R1, the grid pattern of fine metal wires of a width Wyb in the connecting sections of the Y axis direction electrode part 3 is hidden by the grid pattern of fine metal wires of a width Wx in the connecting sections of the X axis direction electrode part 2; thus, only the grid pattern of fine metal wires of a width Wx in the connecting sections of the X axis direction electrode part 2 is visible.

FIG. 6 is a cross-sectional view (a cross-sectional view C-C) along the line C-C in FIG. 5. In other words, FIG. 6 is a cross-sectional view (a cross-sectional view C-C) of a portion of the region R1 included in the bridge region.

As shown in FIG. 6, in the bridge region, the width Wx of the fine metal wires (201 to 203 in FIG. 6, for example) of the X axis direction electrode part 2 is greater than the width Wy of the fine metal wires (301 to 303 in FIG. 6, for example) of the fine metal wires in the Y axis direction electrode part 3. Therefore, when the touch panel TP is viewed from directly above the first main surface of the substrate 1, the grid pattern of the fine metal wires of a width Wyb of the connecting sections of the Y axis direction electrode part 3 is hidden in the bridge regions (region R1, for example) by the grid pattern of the fine metal wires of a width Wx in the connecting sections of the X axis direction electrode part 2.

Furthermore, when the positional alignment tolerance “diff”, which is the positional shift error that can be generated in the bridge regions between the pattern formed by the fine metal wires included in the connecting section of the X axis direction electrode part 2 and the pattern formed by the fine metal wires included in the connecting section of the Y axis direction electrode part 3, the width Wx of the fine metal wires of the X axis direction electrode part 2, and the width Wyb of the fine metal wires of the Y axis direction electrode part 3 satisfy the following: Wx≧Wyb+2×diff.

Then, when the touch panel TP is viewed from directly above the first main surface of the substrate 1, it is certain that the grid pattern of the fine metal wires of a width Wyb in the connecting sections of the Y axis direction electrode part 3 will be hidden by the grid pattern of the fine metal wires of a width Wx in the connecting sections of the X axis direction electrode part 2 in the bridge regions (region R1, for example).

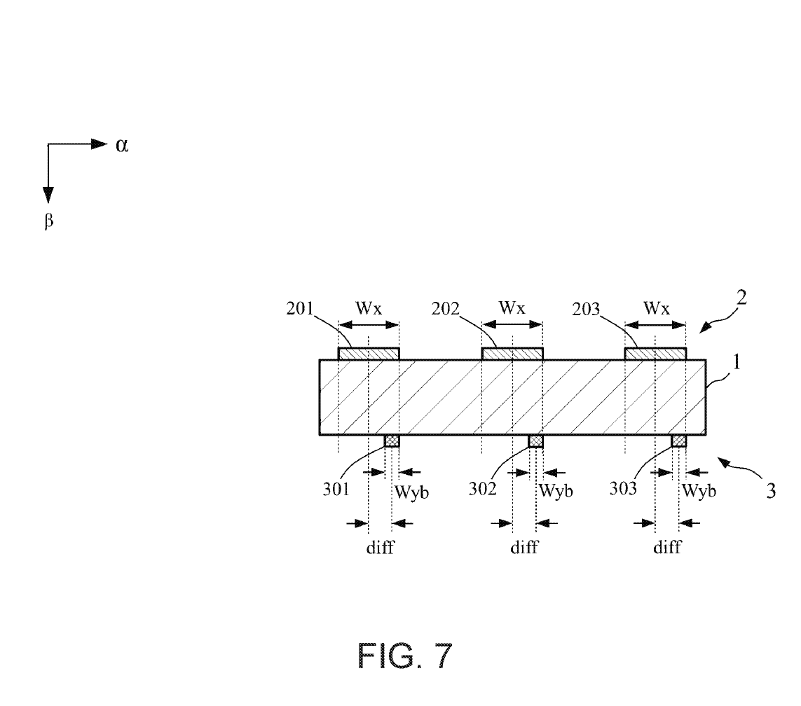

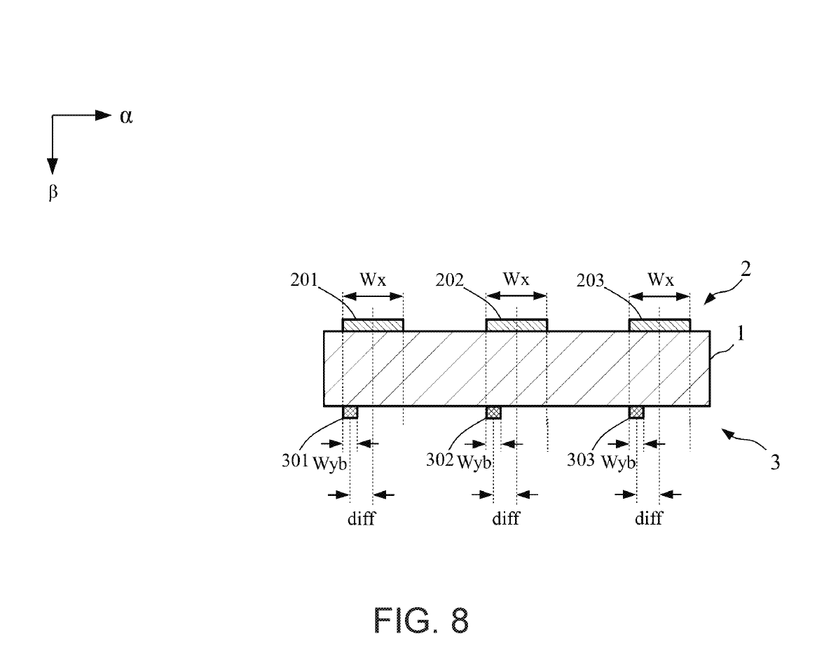

This will be explained with reference to FIGS. 7 and 8.

As shown in FIGS. 6 to 8, αβ coordinates (an α axis, a β axis) are set in FIGS. 6 to 8.

FIG. 7 is a cross-sectional view C-C when the grid pattern of the fine metal wires of a width Wyb of the connecting sections of the Y axis direction electrode part 3 is shifted in the right direction (positive direction of the α axis) in FIG. 7 by the positional alignment tolerance “diff” with respect to the grid pattern of the fine metal wires of a width Wx in the connecting sections of the X axis direction electrode part 2.

FIG. 8 is a cross-sectional view C-C when the grid pattern of the fine metal wires of a width Wyb of the connecting sections of the Y axis direction electrode part 3 is shifted in the left direction (negative direction of the α axis) in FIG. 8 by the positional alignment tolerance “diff” with respect to the grid pattern of the fine metal wires of a width Wx in the connecting sections of the X axis direction electrode part 2.

As can be seen from FIGS. 7 and 8, when the largest difference in the a-axis direction between the center of the fine metal wires (301 to 303) of a width Wyb in the connecting sections of the Y axis direction electrode part 3 and the center of the fine metal wires (201 to 203) of a width Wx in the connecting sections of the X axis direction electrode part 2 is set as “diff”,

(1) it is possible for the center of the fine metal wires (301 to 303) of a width Wyb in the connecting sections of the Y axis direction electrode part 3 to shift by “diff” in the positive direction of the a-axis with respect to the center of the fine metal wires (201 to 203) of a width Wx in the connecting sections of the X axis direction electrode part 2, and
(2) it is possible for the center of the fine metal wires (301 to 303) of a width Wyb in the connecting sections of the Y axis direction electrode part 3 to shift by “diff” in the negative direction of the a-axis with respect to the center of the fine metal wires (201 to 203) of a width Wx in the connecting sections of the X axis direction electrode part 2.

Therefore, if the relationship Wx≧Wyb+2×diff is satisfied, when the touch panel TP is viewed from directly above the first main surface of the substrate 1, it is certain that the grid pattern of the fine metal wires of a width Wyb in the connecting sections of the Y axis direction electrode part 3 will be hidden in the bridge regions (region R1, for example) by the grid pattern of the fine metal wires of a width Wx in the connecting sections of the X axis direction electrode part 2.

As mentioned above, on the touch panel TP (the conductive sheet), the width Wx of the fine metal wires in the X axis direction electrode part 2 is wider than the width Wyb of the fine metal wires in the Y axis direction electrode part 3 in the regions (bridge regions) in which the pattern of the fine metal wires of the X axis direction electrode part 2 formed on the first main surface of the substrate 1 overlaps in a plan view the pattern of the fine metal wires in the Y axis direction electrode part 3 formed on the second main surface of the substrate 1. As a result, when the touch panel TP (conductive sheet) is viewed from directly above the first main surface of the substrate 1, it is possible to make the pattern of the fine metal wires of the Y axis direction electrode part 3 not visible in the bridge regions as a result of being hidden by the pattern of fine metal wires in the X axis direction electrode part 2.

Furthermore, on the touch panel TP (conductive sheet), “diff”, Wx, and Wyb are configured to satisfy the following: Wx≧Wyb+2×diff, where the positional alignment tolerance “diff” is the positional shift error that can be generated in the bridge regions between the pattern formed by the fine metal wires included in the connecting sections of the X axis direction electrode part 2 and the pattern formed by the fine metal wires included in the connecting sections of the Y axis direction electrode part 3, Wx is the width of the fine metal wires in the X axis direction electrode part 2, and Wyb is the width of the fine metal wires in the Y axis direction electrode part 3.

Therefore, on the touch panel TP (conductive sheet), it is certain that the grid pattern of the fine metal wires of a width Wyb in the connecting sections of the Y axis direction electrode part 3 will be hidden in the bridge regions by the grid pattern of the fine metal wires of a width Wx in the connecting sections of the X axis direction electrode part 2 when the touch panel TP is viewed from directly above the first main surface of the substrate 1. As a result, even when the touch panel TP is disposed on a display surface of a liquid crystal display device or the like, there is no possibility that both the pattern of the fine metal wires of the X axis direction electrode part 2 and the pattern of the fine metal wires of the Y axis direction electrode part 3 will be visible in the bridge regions on the second main surface side of the touch panel TP, and it is possible to appropriately prevent the generation of interference. Therefore, by using the touch panel TP in a display device or the like, it is possible to ensure good visibility of displayed images.

In the regions outside the bridge regions, there are no sections where the pattern of the fine metal wires of the X axis direction electrode part 2 overlaps the pattern of the fine metal wires of the Y axis direction electrode part 3 in a plan view.

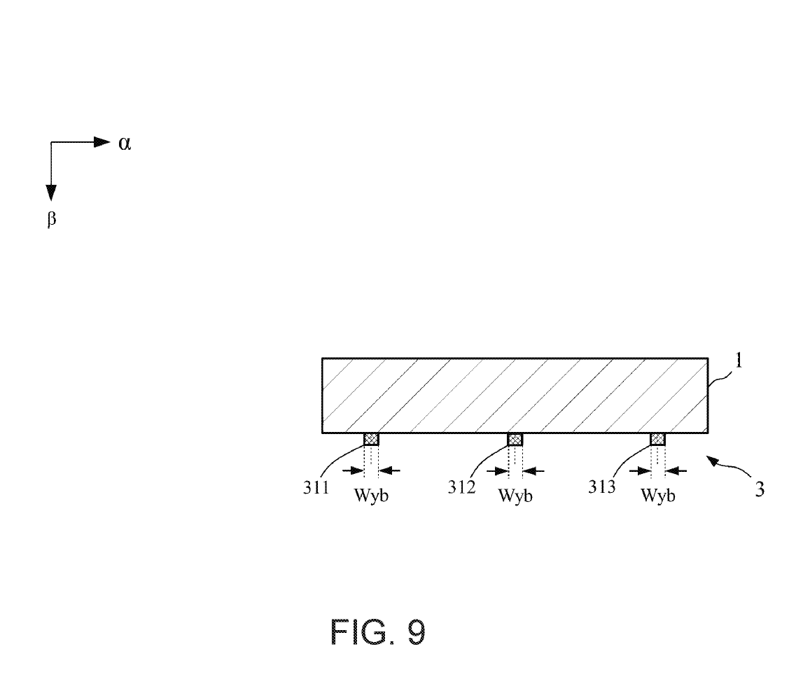

FIG. 9 is a cross-sectional view (a cross-sectional view D-D) along the line D-D in FIG. 5.

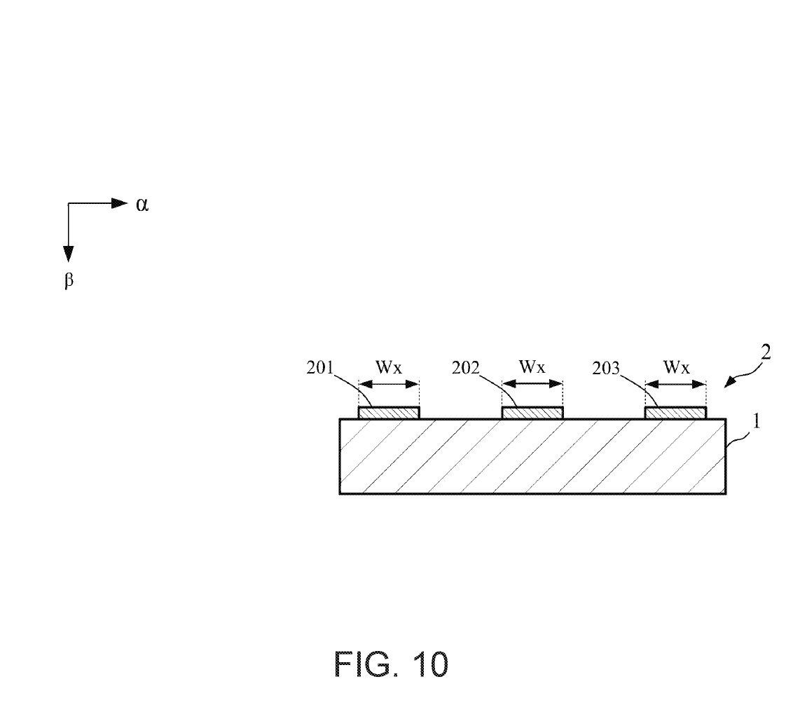

FIG. 10 is a cross-sectional view (a cross-sectional view E-E) along the line E-E in FIG. 5.

As can be seen from FIGS. 9 and 10, in the regions outside the bridge regions, there are no sections where the pattern of the fine metal wires of the X axis direction electrode part 2 and the pattern of the fine metal wires of the Y axis direction electrode part 3 overlap in a plan view. Therefore, interference resulting from the pattern of the fine metal wires of the X axis direction electrode part 2 and the pattern of the fine metal wires of the Y axis direction electrode part 3 overlapping will not be generated.

<Method of Manufacturing the Touch Panel TP>

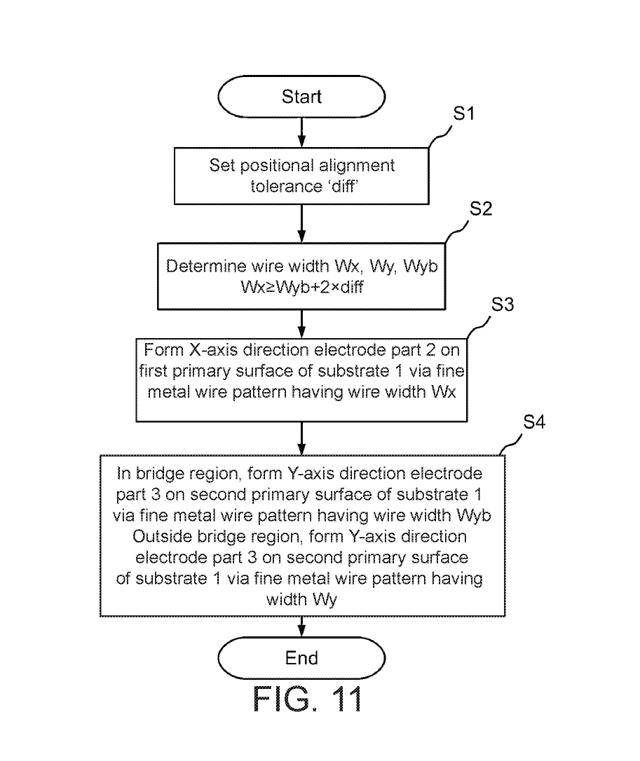

Next, an example of a method of manufacturing the touch panel TP will be explained using FIG. 11.

FIG. 11 is a flow chart of one example of a manufacturing method of the touch panel TP.

(S1):

In Step S1, the positional alignment tolerance “diff,” which is generated when the touch panel TP is manufactured, is set. In other words, when the fine metal wires of the X axis direction electrode part 2 are formed on the first main surface of the substrate 1 and the fine metal wires of the Y axis direction electrode part 3 are formed on the second main surface of the substrate 1, the positional alignment tolerance “diff” is set as the positional shift error that can be generated in the bridge regions between the pattern formed by the fine metal wires included in the connecting sections of the X axis direction electrode part 2 and the pattern formed by the fine metal wires included in the connecting sections of the Y axis direction electrode part 3.

It is preferable that the positional alignment tolerance “diff” be set in accordance with the precision (tolerance) of the manufacturing device of the touch panel TP.

(S2):

In Step S2, Wx, which is the width of the fine metal wires of the X axis direction electrode part 2, Wyb, which is the width of the fine metal wires of the Y axis direction electrode part 3 in the bridge regions, and Wy, which is the width of the fine metal wires of the Y axis direction electrode part 3 in the regions outside the bridge regions, are set. Specifically, Wx, which is the width of the fine metal wires of the X axis direction electrode part 2, Wyb, which is the width of the fine metal wires of the Y axis direction electrode part 3 in the bridge regions, and Wy, which is the width of the fine metal wires of the Y axis direction electrode part 3 in the regions outside the bridge regions, are set such that: Wx≧Wyb+2×diff, Wy>Wyb.

In the present embodiment, Wx=Wy. The present invention is not limited to this however, and Wx and Wy may be set to differing widths.

(S3):

In Step S3, the X axis direction electrode part 2 is formed on the first main surface of the substrate 1 by forming patterns of fine metal wires with the width Wx determined in Step S2 on the first main surface of the substrate 1. In other words, by forming patterns of fine metal wires of the width Wx in the regions indicated by the X axis direction electrode parts 2l to 2n shown in FIG. 1, the X axis electrode part 2 is formed on the first main surface of the substrate 1.

(S4):

In Step S4, the Y axis direction electrode part 3 is formed on the second main surface of the substrate 1 by forming patterns of fine metal wires with the width determined in Step S2 on the second main surface of the substrate 1.

Specifically,

(1) In the bridge regions, the Y axis direction electrode part 3 is formed on the second main surface of the substrate 1 via patterns of fine metal wires of the width Wyb.

(2) In the regions outside the bridge regions, the Y axis direction electrode part 3 is formed on the second main surface of the substrate 1 via patterns of fine metal wires of the width Wy.

In other words, via the above-mentioned treatment, the Y axis direction electrode part 3 is formed on the second main surface of the substrate 1 by forming patterns of fine metal wires of the width Wy in the regions indicated by the Y axis direction electrode parts 3l to 3n shown in FIG. 1.

By performing the above-mentioned treatment (steps), it is possible to manufacture the touch panel TP.

Steps S3 and S4 may be switched with each other, or may be performed simultaneously.

In addition, steps of forming a protective layer that protects the X axis direction electrode part 2 formed on the first main surface of the substrate 1 and forming a protective layer that protects the Y axis direction electrode part 3 formed on the second main surface of the substrate 1 may be added to the above-mentioned method of manufacturing the touch panel TP.

### Embodiment 2

Next, Embodiment 2 will be described.

Below, parts particular to the present embodiment will be described, and a detailed description of the parts similar to the embodiment described above will be omitted.

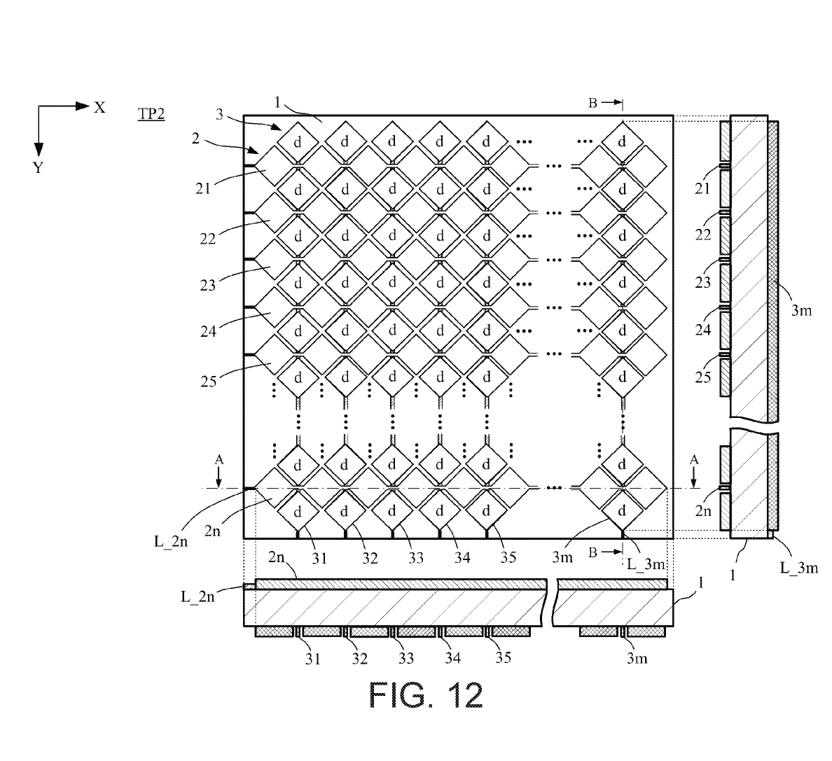

FIG. 12 is a schematic configuration diagram of a touch panel TP2 (one example of a conductive sheet) according to Embodiment 2. Specifically, FIG. 12 shows a plan view of the touch panel TP, a cross-sectional view A-A (bottom of the figure), and a cross-sectional view B-B (right side of the figure).

The touch panel TP2 of the present embodiment has a configuration in which, in the touch panel TP of Embodiment 1: (1) dummy electrodes (the diamond-shaped electrodes with a “d” in FIG. 12) are provided in regions that overlap in a plan view the electrodes of the Y axis direction electrode part 3 on the first main surface of the substrate 1; and (2) in which dummy electrodes are further provided in regions that overlap the electrodes of the X axis direction electrode part 2 in a plan view on the second main surface of the substrate 1.

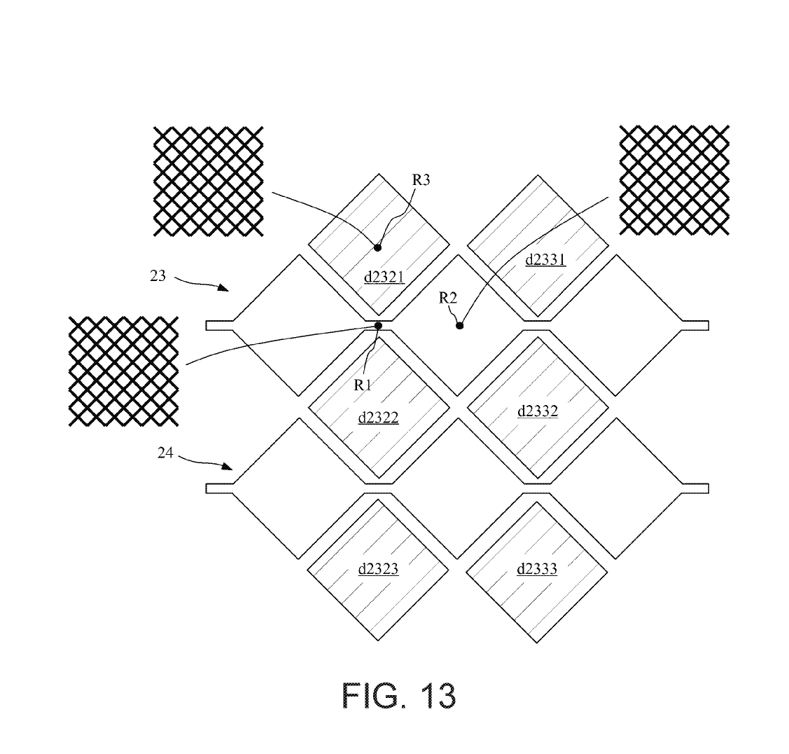

FIG. 13 enlarges a region that is a portion of the touch panel TP2 of FIG. 12 in a plan view, and shows only dummy electrodes (d2321 to d2323, d2331 to d2333) and the X axis direction electrode part 2 formed on the first main surface of the substrate 1. In addition, FIG. 13 shows patterns of fine metal wires included in the regions R1, R2, and R3.

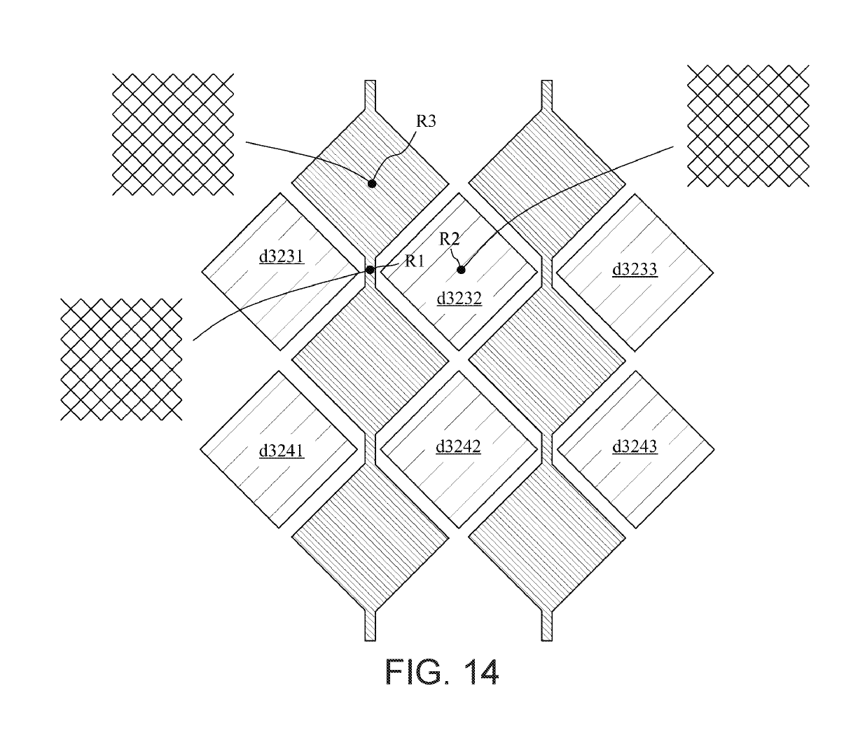

FIG. 14 enlarges a region that is a portion of the touch panel TP2 of FIG. 12 in a plan view, and shows only dummy electrodes (d3231 to d3233, d3241 to d3243) and the Y axis direction electrode part 3 formed on the second main surface of the substrate 1. In addition, FIG. 12 shows patterns of fine metal wires included in the regions R1, R2, and R3.

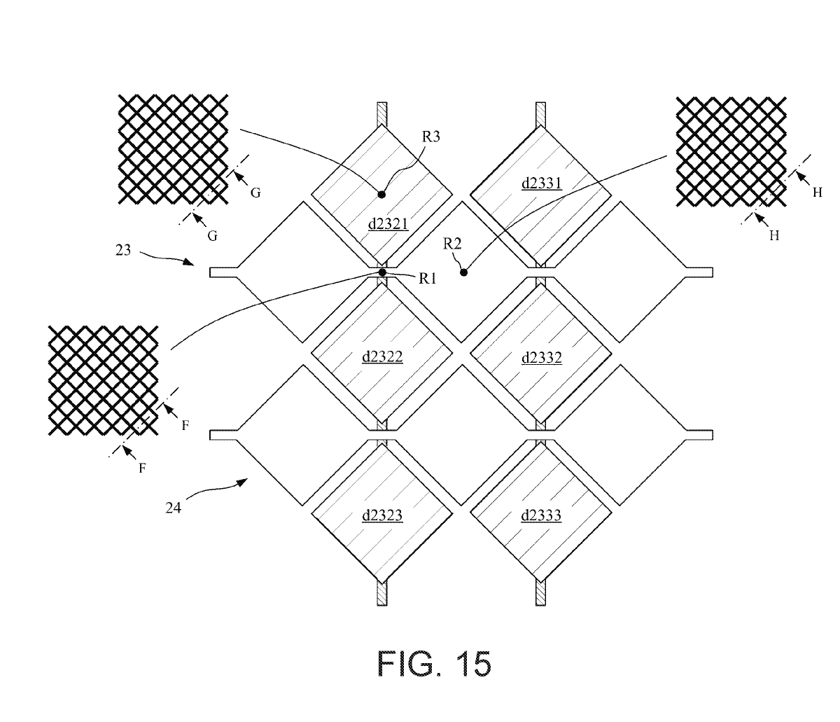

FIG. 15 enlarges a region that is a portion of the touch panel TP2 of FIG. 12 in a plan view, and is a plan view as seen from directly above the first main surface of the substrate 1. In addition, FIG. 15 shows patterns of fine metal wires included in the regions R1, R2, and R3.

As shown in FIG. 13, in the touch panel TP2 of the present embodiment, Wx1 is the width of the fine metal wires included in the dummy electrodes (d2321 to d2323, d2331 to d2333) and the X axis direction electrode part 2 formed on the first main surface of the substrate 1.

In addition, as shown in FIG. 14, in the touch panel TP2, Wy1 is the width of the fine metal wires included in the dummy electrodes (d3231 to d3233, d3241 to d3243) and the Y axis direction electrode part 3 formed on the second main surface of the substrate 1.

The pattern of the fine metal wires included in the X axis direction electrode part 2 is identical to the pattern of the fine metal wires included in the Y axis direction electrode part 3. In addition, the pattern of the fine metal wires included in the dummy electrodes formed on the first main surface of the substrate 1 is identical to the pattern of the fine metal wires included in the dummy electrodes formed on the second main surface of the substrate 1.

When the positional alignment tolerance “diff” is set as the positional shift error that can be generated between the pattern formed by the fine metal wires included in the X axis direction electrode part 2 formed on the first main surface of the substrate 1 (or, alternatively, the dummy electrodes formed on the first main surface of the substrate 1) and the pattern formed by the fine metal wires included in the Y axis direction electrode part 3 formed on the second main surface of the substrate 1 (or, alternatively, the dummy electrodes formed on the second main surface of the substrate 1), then, in the touch panel TP2, the line width Wx1 and the line width Wy1 satisfy the following: Wx1≧Wy1+2×diff.

In other words, in the touch panel TP2, so that a relationship identical to the relationship between Wx, which is the width of the fine metal wires of the X axis direction electrode part 2 in the bridge regions of Embodiment 1, and Wyb, which is the width of the fine metal wires of the Y axis electrode part 3 in the bridge regions of Embodiment 1, exists in the regions outside the bridge regions: (1) dummy electrodes and the X axis direction electrode part 2 are formed on the first main surface of the substrate 1, and (2) dummy electrodes and the Y axis direction electrode part 3 are formed on the second main surface of the substrate 1.

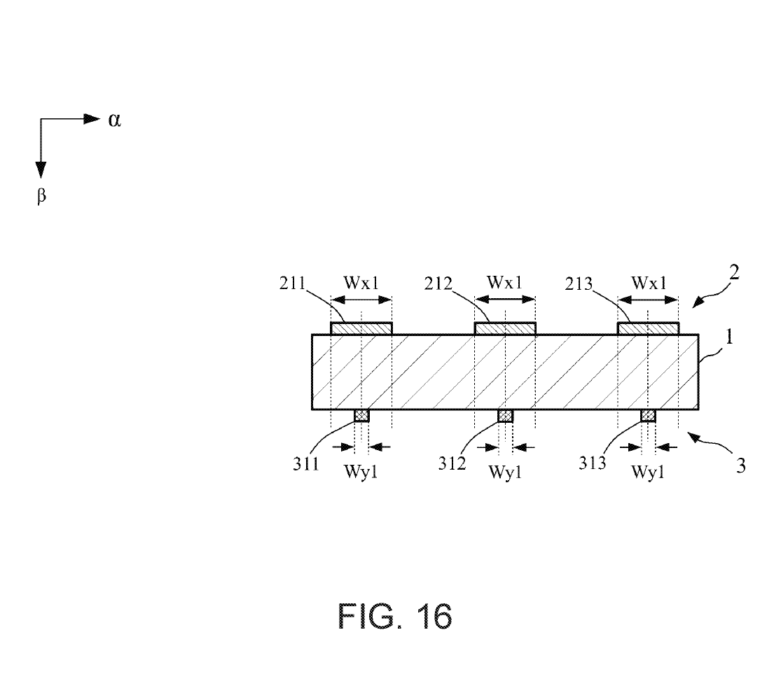

Therefore, a cross-section F-F (a cross-section of a region that is a portion of the region R1) taken along the line F-F in FIG. 15 looks like the cross-section shown in FIG. 16. While omitted from the drawings, a cross-section G-G (a cross-section of a region that is a portion of the region R3) taken along the line G-G in FIG. 15, and a cross-section H-H (a cross-section of a region that is a portion of the region R2) taken along the line H-H in FIG. 15 are identical to the cross-section shown in FIG. 16.

As can be from FIG. 16, on the touch panel TP2, if the following relationship is satisfied in Embodiment 1 in a manner similar to that described using FIGS. 6 to 8: Wx1≧Wy1+2×diff.

Then, when the touch panel TP2 is viewed from directly above the first main surface of the substrate 1:

(1) the grid pattern of the fine metal wires of a width Wy1 in the connecting sections of the Y axis direction electrode part 3 is hidden in the bridge regions by the grid pattern of the fine metal wires of a width Wx1 in the connecting sections of the X axis direction electrode part 2,

(2) in regions that are outside the bridge regions and are regions in which the X axis direction electrode part 2 is formed on the first main surface of the substrate 1, the grid pattern of the fine metal wires of a width Wy1 in the dummy electrodes formed on the second main surface of the substrate 1 is hidden by the grid pattern of the fine metal wires of a width Wx1 in the X axis direction electrode part 2, and

(3) in regions that are outside the bridge regions and are regions in which dummy electrodes are formed on the first main surface of the substrate 1, the grid pattern of the fine metal wires of a width Wy1 in the Y axis direction electrode part 3 formed on the second main surface of the substrate 1 is hidden by the grid pattern of the fine metal wires of a width Wx1 in the dummy electrodes formed on the first main surface of the substrate 1.

As mentioned above, in the touch panel TP2 (conductive sheet), the width Wx1 of the fine metal wires of the dummy electrodes and the X axis direction electrode part 2 formed on the first main surface of the substrate 1 is wider than the width Wy1 of the fine metal wires of the dummy electrodes and the Y axis direction electrode part 3 formed on the second main surface of the substrate 1. As a result, when the touch panel TP2 (conductive sheet) is viewed from directly above the first main surface of the substrate 1, it is possible to make the patterns of the fine metal wires of the dummy electrodes and the Y axis direction electrode part 3 formed on the second main surface of the substrate 1 not visible as a result of the above-mentioned patterns being hidden by the patterns of the fine metal wires of the dummy electrodes and the X axis direction electrode part 2 formed on the first main surface of the substrate 1.

Furthermore, in the touch panel TP2 (conductive sheet), the line width Wx1 and the line width Wy1 are configured so as to satisfy the following: Wx1≧Wy1+2×diff.

Therefore, in the touch panel TP2 (conductive sheet), when the touch panel TP2 is viewed from directly above the first main surface of the substrate 1, it is certain that the grid pattern of the fine metal wires of a width Wy1 in the dummy electrodes and the Y axis direction electrode part 3 formed on the second main surface of the substrate 1 will be hidden by the grid pattern of the fine metal wires of a width Wx1 in the dummy electrodes and the X axis direction electrode part 2 formed on the first main surface of the substrate 1. As a result, even when the touch panel TP2 is disposed on a display surface of a liquid crystal display device or the like, there is no possibility that both the pattern of the fine metal wires formed on the first main surface of the substrate 1 and the pattern of the fine metal wires of the formed on the second main surface of the substrate 1 will be visible in the bridge regions on the second main surface side of the touch panel TP2, and it is possible to appropriately prevent the generation of interference. Therefore, by using the touch panel TP2 in a display device or the like, it is possible to ensure good visibility of displayed images.

<Method of Manufacturing the Touch Panel TP2>

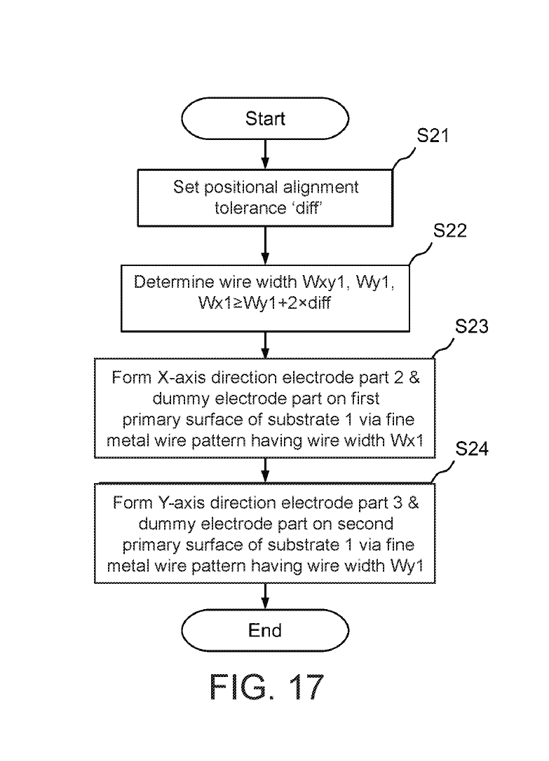

Next, an example of a method manufacturing the touch panel TP2 will be explained using FIG. 17.

FIG. 17 is a flow chart of one example of a manufacturing method of the touch panel TP2.

(S21):

In Step S21, “diff,” which is the positional alignment tolerance generated when the touch panel TP is manufactured, is set. In other words, when the fine metal wires of the dummy electrodes and the X axis direction electrode part 2 are formed on the first main surface of the substrate 1 and the fine metal wires of the dummy electrodes and the Y axis direction electrode part 3 are formed on the second main surface of the substrate 1, the positional alignment tolerance “diff” is set as the positional shift error that can be generated between the pattern formed by the fine metal wires on the first main surface of the substrate 1 and the pattern formed by the fine metal wires on the second main surface of the substrate 1.

It is preferable that the positional alignment tolerance “diff” be set in accordance with the precision (tolerance) of the manufacturing device of the touch panel TP2.

(S22):

In Step S22, Wx1, which is the width of the fine metal wires of the dummy electrodes and the X axis direction electrode part 2 formed on the first main surface of the substrate 1, and Wy1, which is the width of the fine metal wires of the dummy electrodes and the Y axis direction electrode part 3 formed on the second main surface of the substrate 1, are set. Specifically, Wx1 and Wy1 are set such that: Wx1≧Wy1+2×diff, where Wx is the width of the fine metal wires of the dummy electrodes and the X axis direction electrode part 2 formed on the first main surface of the substrate 1, and Wy1 is the width of the fine metal wires of the dummy electrodes and the Y axis direction electrode part 3 formed on the second main surface of the substrate 1.

(S23):

In Step S23, dummy electrodes and the X axis direction electrode part 2 are formed on the first main surface of the substrate 1 by forming patterns of fine metal wires with the width Wx1 determined in Step S2 on the first main surface of the substrate 1. In other words, by forming patterns of fine metal wires of the width Wx in the regions indicated by the X axis direction electrode parts 2l to 2n shown in FIG. 12 and the regions with a “d,” dummy electrodes and the X axis electrode part 2 are formed on the first main surface of the substrate 1.

(S24):

In Step S24, dummy electrodes and the Y axis direction electrode part 3 are formed on the second main surface of the substrate 1 by forming patterns of fine metal wires with the width Wy1 determined in Step S2 on the second main surface of the substrate 1.

By performing the above-mentioned treatment (steps), it is possible to manufacture the touch panel TP2.

Steps S23 and S24 may be switched with each other, or may be performed simultaneously.

In addition, steps of forming a protective layer that protects the dummy electrodes and the X axis direction electrode part 2 formed on the first main surface of the substrate 1 and forming a protective layer that protects the dummy electrodes and the Y axis direction electrode part 3 formed on the second main surface of the substrate 1 may be added to the above-mentioned method of manufacturing the touch panel TP.

### Other Embodiments

In the above-mentioned embodiments, patterns of fine metal wires in the X axis direction electrode part 2, the Y axis direction electrode part 3, and the dummy electrodes were described as grid patterns. The present invention is not limited to this however, and a honeycomb pattern (a hexagonal cell pattern), or a random pattern may be used, for example.

In the above-mentioned embodiments, a case was explained in which the X axis direction electrode part 2 (in Embodiment 2, the X axis direction electrode part 2 and the dummy electrodes) was formed on the first main surface of the substrate 1, and the Y axis direction electrode part 3 (in Embodiment 2, the Y axis direction electrode part 3 and the dummy electrodes) was formed on the second main surface of the substrate 1. The present invention is not limited to this configuration, however, and the reverse configuration may be used instead. In other words, in the touch panel, the X axis direction electrode part 2 (in Embodiment 2, the X axis direction electrode part 2 and the dummy electrodes) may be formed on the second main surface of the substrate 1, and the Y axis direction electrode part 3 (in Embodiment 2, the Y axis direction electrode part 3 and the dummy electrodes) may be formed on the first main surface of the substrate 1.

In addition, in the above mentioned embodiments, a touch panel was described in which the X axis direction electrode part 2 (in Embodiment 2, the X axis direction electrode part 2 and the dummy electrodes) and the Y axis direction electrode part 3 (in Embodiment 2, the Y axis direction electrode part 3 and the dummy electrodes) were respectively formed on both surfaces (the first main surface and the second main surface) of the substrate 1. The present invention is not limited to this configuration, however, and, in the touch panel, the X axis direction electrode part 2 (in Embodiment 2, the X axis direction electrode part 2 and the dummy electrodes) and the Y axis direction electrode part 3 (in Embodiment 2, the Y axis direction electrode part 3 and the dummy electrodes) may be respectively formed in different layers (substrates).

For example, the touch panel may be configured by forming the X axis direction electrode part 2 (in Embodiment 2, the X axis direction electrode part 2 and the dummy electrodes) on a first substrate, forming the Y axis direction electrode part 3 (in Embodiment 2, the Y axis direction electrode part 3 and the dummy electrodes) on a second substrate, and then bonding the first substrate and the second substrate. Even in such a case, it is possible to apply the present invention by realizing a relationship (the positional relationship explained using FIGS. 6 to 8, or the like, for example) identical to that of the above-mentioned embodiments.

In addition, a touch panel display device may be realized by adding a display panel, a display panel control unit, and the like to the touch panels TP, TP2 of the above-mentioned embodiments.

The order of execution for the processing methods (the method of manufacturing the touch panel, for example) in the embodiments described above are not necessarily limited by the description of the embodiments described above. The order of execution can be changed within a scope that does not depart from the gist of the present invention.

A computer program that executes the methods described above in a computer and a computer readable storage medium that stores such a program are included in the scope of the present invention. Here, examples of a computer readable storage medium include a floppy disk, hard disk, CD-ROM, MO, DVD, high-density DVD, next-generation DVD, and semiconductor memory, for example.

The computer program described above is not limited to being stored in the storage medium described above and may be transmitted through a network represented by an electric communication line, wireless or wired communication line, or the internet, or the like.

In addition, in the above-mentioned embodiments, only the main components required for the embodiments are described from among the components of the invention in a simplified manner. Accordingly, other appropriate components not described in the above-mentioned embodiments may be included. In addition, in the drawings and the embodiments described above, the dimensions of the various members do not necessarily faithfully represent the actual dimensions, dimension ratios, or the like. Therefore, it is possible to modify the dimensions, dimensional ratios, and the like without departing from the scope of the present invention.

The specific configurations of the present invention are not limited by the embodiments described above, and various changes and modifications are possible within a range that does not depart from the gist of the present invention.

<Addendum>

The present invention can also be expressed as follows.

A first configuration is a conductive sheet (a touch panel sheet, for example) that includes a first electrode part and a second electrode part.

The first electrode part includes a plurality of fine metal wires formed in a first plane (a first main surface of a substrate [alternatively, a first layer of a multilayer substrate], for example).

The second electrode part includes a plurality of fine metal wires formed in a second plane (a second main surface of a substrate [alternatively, a second layer of a multilayer substrate], for example).

The wiring pattern of the plurality of fine metal wires included in the first electrode part is identical to the wiring pattern of the plurality of fine metal wires included in the second electrode part in the bridge regions in which the first electrode part and the second electrode part overlap in a plan view.

When viewed from the side of the first plane, in the bridge regions, the fine metal wires included in the first electrode part are formed such that the width thereof is greater than the width of the fine metal wires included in the second electrode part such that the fine metal wires included in the second electrode part are hidden by the fine metal wires included in the first electrode part.

In such a conductive sheet, the width of the fine metal wires in the first electrode part is larger (thicker) than the width of the fine metal wires in the second electrode part in the bridge regions in which the pattern of the fine metal wires of the first electrode part formed in the first plane and the pattern of the fine metal wires of the second electrode part formed in the second plane overlap in a plan view. As a result, when the conductive sheet is viewed from directly above the first plane, it is possible to make the pattern of the fine metal wires of the second electrode part not be visible in the bridge regions as a result of this pattern being hidden by the pattern of the fine metal wires of the first electrode part.

Therefore, even when such a conductive sheet is disposed on a display surface of a liquid crystal display device or the like, there is no possibility that both the pattern of the fine metal wires in the first electrode part and the pattern of the fine metal wires in the second electrode part will be visible in the bridge regions on the second plane side of the conductive sheet, and it is possible to appropriately prevent the generation of interference. Therefore, by using such a conductive sheet in a display device or the like, it is possible to ensure good visibility of displayed images.

“The wiring pattern of the plurality of fine metal wires included in the first electrode part is identical to the wiring pattern of the plurality of fine metal wires included in the second electrode part” means that the patterns have the same shape when the line width is ignored (when the line width is “0”). In other words, the wiring patterns being identical means that the shape formed via a central line of the wiring patterns (a line that connects the center of the width of the lines) is identical (congruent).

A second configuration is configured such that, in the first configuration, the width of the fine metal wires included in the first electrode part is larger in a plan view than the width of the fine metal wires included in the second electrode part in the regions other than the bridge region.

As a result, in the conductive sheet, by having the line width Wx correspond to the width of the fine metal wires in the electrodes formed in the first plane, the line width Wy correspond to the width of the fine metal wires in the electrodes formed in the second plane, and having Wx>Wy, it is possible to appropriate prevent interference in the bridge regions and further simplify the manufacturing process, for example. In other words, in the above-mentioned case, it is not necessary to change the line width between the bridge regions and any other regions; thus, it is possible to simplify the manufacturing process.

The third configuration is configured such that, in the first or second configuration, when Wx is the width of the fine metal wires included in the first electrode part, Wy is the width of the fine metal wires included in the second electrode part, and “diff” is the positional shift error in the position of the second electrode with respect to the position of the first electrode in a plan view, the line width Wx of the fine metal wires included in the first electrode part is a value that satisfies Wx≧Wy+2×diff.

As a result, on the conductive sheet, when “diff” is the positional shift error and the conductive sheet is viewed from directly above the first plane, it is certain that the grid pattern of the fine metal wires of a width Wy in the second electrode part will be hidden in the bridge regions by the grid pattern of the fine metal wires of a width Wx in the first electrode part. As a result, even when such a conductive sheet is disposed on a display surface of a liquid crystal display device or the like, there is no possibility that both the pattern of the fine metal wires in the first electrode part and the pattern of the fine metal wires in the second electrode part will be visible in the bridge region on the side of the conductive sheet opposite to the first plane, and it is possible to appropriately prevent the generation of interference. Therefore, by using such a conductive sheet in a display device or the like, it is possible to ensure good visibility of displayed images.

A fourth configuration further includes first dummy electrodes and second dummy electrodes in any one of the first to third configurations.

When a region where the second electrode part exists and the first electrode part does not exist in a plan view is set as a first dummy region, and a region in which the second electrode part does not exist and the first electrode part does exist in a plan view is set as a second dummy region, the first dummy electrode part includes a plurality of fine metal wires formed in a region that corresponds to the first dummy region in the first plane in which the first electrode part is formed.

The second dummy electrode part includes a plurality of fine metal wires formed in a region that corresponds to the second dummy region in the second plane in which the second electrode part is formed.

In the region in which the first dummy electrode part and the second electrode part overlap in a plan view:

(A1) the wiring pattern of the plurality of fine metal wires included in the first dummy electrode part is identical to the wiring pattern of the plurality of fine metal wires included in the second electrode part, and

(A2) the width of the fine metal wires included in the first dummy electrode part is larger than the width of the fine metal wires included in the second electrode part.

In the region in which the first electrode part and the second dummy electrode part overlap in a plan view:

(B1) the wiring pattern of the plurality of fine metal wires included in the first electrode part is identical to the wiring pattern of the plurality of the fine metal wires included in the second dummy electrode part, and

(B2) the width of the fine metal wires included in the first electrode part is larger than the width of the fine metal wires included in the second dummy electrode part.

In the conductive sheet, the width of the fine metal wires in the first dummy electrode part and the first electrode part formed in the first plane is wider than the width of the fine metal wires in the second dummy electrode part and the second electrode part formed in the second plane. As a result, when the conductive sheet is viewed from directly above the first plane, it is possible make the patterns of the fine metal wires of the dummy electrode part and the Y axis direction electrode part 3 formed in the second plane to not be visible as a result of these patterns being hidden by the patterns of the fine metal wires of the dummy electrode part and the X axis direction electrode part 2 formed in the first plane.

Therefore, even when such a conductive sheet is disposed on a display surface of a liquid crystal display device or the like, there is no possibility that both the patterns of the fine metal wires formed in the first plane and the patterns of the fine metal wires formed in the second plane will be visible on the side of the conductive sheet opposite to the first plane, and it is possible to appropriately prevent the generation of interference. Therefore, by using such a conductive sheet in a display device or the like, it is possible to ensure good visibility of displayed images.

A fifth configuration is a configuration in which, in the fourth configuration, the width of the fine metal wires included in the first electrode part and the width of the fine metal wires included in the first dummy electrode part are of an identical width, Wx1, and the width of the fine metal wires included in the second electrode part and the width of the fine metal wires included in the second dummy electrode part are of an identical width, Wy1.

In a plan view, when “diff2” is a positional alignment tolerance for the position of the second electrode part with respect to the position of the first electrode part, Wx1, which is the width of the fine metal wires included in the first electrode part and the first dummy electrode part, satisfies the following: Wx1≧Wy1+2×diff2.

In the conductive sheet, Wx1, which is the width of the fine metal wires in the first dummy electrode part and first electrode part formed in the first plane, is wider than Wy1, which is the width of the fine metal wires in the second dummy electrode part and the second electrode part formed in the second plane. As result, when the conductive sheet is viewed from directly above the first plane, it is possible to make the patterns of the fine metal wires of the dummy electrode part and the Y axis direction electrode part 3 formed in the second plane to not be visible as a result of these patterns being hidden by the patterns of the fine metal wires of the dummy electrode part and the X axis direction electrode part 2 formed in the first plane.

Furthermore, in the conductive sheet, the width Wx1 and the width Wy1 are configured so as to satisfy the following: Wx1≧Wy1+2×diff.

Therefore, on the conductive sheet, when the conductive sheet is viewed from directly above the first plane, it is certain that the grid pattern of the fine metal wires of a width Wy1 in the second dummy electrode part and the second electrode part formed in the second plane will be hidden by the grid pattern of the fine metal wires of a width Wx1 in the first dummy electrode part and the first electrode part formed in the first plane. Therefore, even when such a conductive sheet is disposed on a display surface of a liquid crystal display device or the like, there is no possibility that both the patterns of the fine metal wires formed in the first plane and the patterns of the fine metal wires formed in the second plane will be visible on the side of the conductive sheet opposite to the first plane, and it is possible to appropriately prevent the generation of interference. Therefore, by using such a conductive sheet in a display device or the like, it is possible to ensure good visibility of displayed images.

A sixth configuration is a touch panel device that includes: a conductive sheet with any one of the first to fifth configurations, and a driving unit that drives the conductive sheet.

As a result, it is possible to realize a touch panel device that uses a conductive sheet that has any one of the first to fifth configurations.

A seventh configuration is a display device that includes a display unit, a control unit that controls the display unit, and a touch panel device of the sixth configuration.

In this manner, it is possible to realize a display device that uses a touch panel device of the sixth configuration.

An eighth configuration is a method of manufacturing a conductive sheet that manufactures a conductive sheet that includes: a first electrode part that includes a plurality of fine metal wires formed in a first plane, and a second electrode part that includes a plurality of fine metal wires formed in a second plane. This method includes an error setting step, a width setting step, a first formation step, and a second formation step.

The error setting step sets the positional alignment tolerance “diff.”

The width setting step sets: (1) Wx, which the is width of the fine metal wires included in the first electrode part; (2) Wyb, which is the width of the plurality of fine metal wires included in the second electrode part in the bridge regions in which the first electrode part and the second electrode part overlap in a plan view; and (2) Wy, which is the width of the plurality of fine metal wires included in the second electrode part in regions other than the bridge regions, so as to satisfy the following: Wx≧Wyb+2×diff, Wy>Wyb.

In the first formation step, the first electrode part is formed in the first plane via a plurality of fine metal wires of a width Wx.

In the second formation step, the second electrode part is formed in the bridge regions in the second plane via a plurality of fine metal wires of a width Wyb, and the second electrode part is formed in regions other than the bridge regions in the second plane via a plurality of fine metal wires of a width Wy.

As a result, it is possible to manufacture a conductive sheet that appropriately prevents interference.

A ninth configuration is a method of manufacturing a conductive sheet that manufactures a conductive sheet that includes: a first dummy electrode section and a first electrode section that include a plurality of fine metal wires formed in the first plane, and a second dummy electrode section and a second electrode section that include a plurality of fine metal wires formed in the second plane. The method includes: an error setting step, a width setting step, a first formation step, and a second formation step.

The error setting step sets the positional alignment tolerance “diff.”

The width setting step sets: (1) Wx1, which is the width of the fine metal wires in the first electrode part and the first dummy electrode part, and (2), Wy1, which is the width of the fine metal wires of the second electrode part and the second dummy electrode part, so as to satisfy: Wx1≧Wy1+2×diff.

In the first formation step, the first electrode part and the first dummy electrode part are formed in the first plane via a plurality of fine metal wires of a width Wx.

In the second formation step, the second electrode part and the second dummy electrode part are formed via a plurality of fine metal wires of a width Wy in a second plane.

As a result, it is possible to manufacture a conductive sheet that appropriately prevents interference.

### INDUSTRIAL APPLICABILITY

The present invention is able to realize: a conductive sheet that, even when disposed on a display surface of a liquid crystal display device or the like, appropriately prevents interference and ensures good visibility of displayed images; a touch panel device; a display device; and a method of manufacturing a conductive sheet. Therefore, the present invention is useful in the industrial field of touch panels, and can be implemented in this field.

### DESCRIPTION OF REFERENCE CHARACTERS

TP, TP2 touch panel
1 substrate
2 X axis direction electrode part
3 Y axis direction electrode part

1. A conductive sheet, comprising:
a base sheet;
a first electrode made of a mesh of fine metal wires, formed on a first plane of the base sheet; and
a second electrode made of a mesh of fine metal wires, formed on a second plane of the base sheet, the first electrode intersecting the second electrode in a plan view,
wherein, in a bridge region in which the first electrode and the second electrode intersect with each other in the plan view, a mesh pattern of fine metal wires in the first electrode is identical to and oriented in a same way as a mesh pattern of fine metal wires in the second electrode, and
wherein in the bridge region, the fine metal wires in the first electrode have a larger wire width than the fine metal wires in the second electrode so that that the fine metal wires in the second electrode are hidden behind the fine metal wires in the first electrode.

2. The conductive sheet according to claim 1, wherein in the plan view, in regions other than the bridge region, a wire width of the fine metal wires in the first electrode is the same as a wire width of the fine metal wires in the second electrode.

3. The conductive sheet according to claim 1,
wherein, in the bridge region, the wire width Wx of the fine metal wires in the first electrode satisfies:
Wx≧Wy+2×diff,
where Wy is the wire width of the fine metal wires in the second electrode in the bridge region, and diff is a positional alignment tolerance in a position of the second electrode relative to a position of the first electrode in the plan view.

4. The conductive sheet according to claim 1,
comprising:
a first dummy electrode made of a mesh of fine metal wires, formed on the first plane of the base sheet in a position that corresponds to the second electrode in the plan view; and
a second dummy electrode made of a mesh of fine metal wires, formed on the second plane of the base sheet in a position that corresponds to the first electrode in the plan view,
wherein, in a region where the first dummy electrode and the second electrode overlap in the plan view:
(A1) a mesh pattern of fine metal wires in the first dummy electrode is identical to and oriented in a same way as a mesh pattern of fine metal wires in the second electrode, and
(A2) a wire width of the fine metal wires in the first dummy electrode is larger than the wire width of the fine metal wires in the second electrode, and
wherein, in a region where the first electrode and the second dummy electrode overlap in the plan view:
(B1) a mesh pattern of fine metal wires in the first electrode is identical to and oriented in a same way as a mesh pattern of fine metal wires in the second dummy electrode, and
(B2) the wire width of the fine metals wires in the first electrode is larger than a wire width of the fine metal wires in the second dummy electrode.

5. The conductive sheet according to claim 4,
wherein the wire width of the fine metal wires in the first electrode and the wire width of the fine metal wires in the first dummy electrode are of an identical wire width Wx1,
wherein the wire width of the fine metal wires in the second electrode and the wire width of the fine metal wires in the second dummy electrode are of an identical wire width Wy1,
wherein the wire width Wx1 and the wire width Wy1 satisfy:
Wx1≧Wy1+2×diff2,
where diff2 is a positional alignment tolerance in a position of the second electrode relative to a position of the first electrode in the plan view.

6. A touch panel device, comprising:
the conductive sheet according to claim 1; and
a driving unit that drives the conductive sheet.

7. A display device, comprising:
a display unit;
a control unit that controls the display unit; and
the touch panel device according to claim 6.

8. A method of manufacturing a conductive sheet having a base sheet a first electrode made of a mesh of fine metal wires, formed on a first plane of the base sheet, and a second electrode made of a mesh of fine metal wires, formed on a second plane of the base sheet, said method comprising:
a tolerance setting step of setting a positional alignment tolerance diff;
a wire width determination step of determining (1) a wire width Wx of the fine metal wires in the first electrode, (2) a wire width Wyb of the fine metal wires in the second electrode in a bridge region where the first electrode and the second electrode intersect in a plan view, and (3) a wire width Wy of the fine metal wires in the second electrode in non-bridge regions other than the bridge region so as to satisfy:
Wx≧Wyb+2×diff,
Wy>Wyb;
a first forming step of forming the first electrode on the first plane of the base sheet with the mesh of fine metal wires having the determined wire width Wx; and
a second forming step of forming the second electrode on the second plane of the base sheet with the mesh of fine metal wires having the determined wire widths Wyb and Wy in the bridge region and in the non-bridge regions, respectively.

9. A method of manufacturing a conductive sheet having a base sheet, a first electrode and a first dummy electrode, both made of a mesh of fine metal wires and formed on a first plane of the base sheet, and a second electrode and a second dummy electrode, both made of a mesh of fine metal wires and formed on a second plane of the base sheet, said method comprising:
a tolerance setting step of setting a positional alignment tolerance diff;
a wire width determination step of determining (1) a wire width Wx1 of the fine metal wires in the first electrode and the first dummy electrode and (2) a wire width Wy1 of the fine metal wires in the second electrode and the second dummy electrode so as to satisfy:
Wx1≧Wy1+2×diff;
a first forming step of forming the first electrode and the first dummy electrode in the first plane with the mesh of fine metal wires having the determined wire width Wx1; and
a second forming step of forming the second electrode and the second dummy electrode on the second plane with the mesh of fine metal wires having the determined wire width Wy1.
